(19) United States
(12) Patent Application Publication
(10) Pub. No.: US 2021/0131470 A1
(43) Pub. Date: May 6, 2021

(54) Staple and staple gun therefor

(71) Applicant: Chung-Chih Wei, Taichung (TW)

(72) Inventor: Chung-Chih Wei, Taichung (TW)

(21) Appl. No.: 17/078,686

(22) Filed: Oct. 23, 2020

(30) Foreign Application Priority Data
Oct. 30, 2019 (TW) 108214299

(51) Int. Cl. F16B 15/00

(52) U.S. Cl. CPC F16B 15/0015; F16B 15/0092

(57) ABSTRACT

A staple is provided with two legs each including a forward projection; and a connection member having two ends formed with tops of the legs respectively. In another embodiment, each leg further has a rearward projection. In still another embodiment, the staple is shaped as an L. In yet another embodiment, the staple is shaped as a T.

### BACKGROUND OF THE INVENTION

### 1. Field of the Invention

The invention relates to staples and more particularly to a staple comprising two legs each including a forward projection so that the projections can be guided by two grooved rails of a muzzle of a staple gun to ensure a successful driving operation.

### 2. Description of Related Art

A staple gun or powered stapler is a hand-held machine used to drive heavy metal staples into wood, plastic, or masonry. Staple guns are used in many different applications for affixing a variety of materials including insulation, house wrap, roofing, wiring, carpeting, upholstery, and craft materials.

A conventional U-shaped metal staple is shown in FIGS. 1 and 2. The legs of the staple are supposed to drive into a target (e.g., hard wood) for affixing same. However, the legs may be bent before being driven into the target, i.e., failed.

Thus, the need for improvement still exists.

### SUMMARY OF THE INVENTION

It is therefore one object of the invention to provide a staple comprising two legs each including a forward projection; and a connection member having two ends formed with tops of the legs respectively.

Preferably, each leg further comprises a rearward projection.

The above and other objects, features and advantages of the invention will become apparent from the following detailed description taken with the accompanying drawings.

### BRIEF DESCRIPTION OF THE DRAWINGS

FIG. 1 is a perspective view of a conventional staple;

FIG. 2 is a perspective view of the conventional staple having legs being bent before driving into a target in a driving operation, i.e., failed;

FIG. 3 is a perspective view of a staple according to a first preferred embodiment of the invention;

FIG. 4 is perspective view of a long strip of staples;

FIG. 5 is a perspective view of a staple gun according to the invention;

FIG. 6 is a detailed view of the area in circle A of FIG. 5;

FIG. 7 is a longitudinal sectional of the long strip of staples at the muzzle of the staple gun;

FIG. 8 is a perspective view of a staple according to a second preferred embodiment of the invention;

FIG. 9 is a perspective view of a staple according to a third preferred embodiment of the invention;

FIG. 10 is a perspective view of a staple according to a fourth preferred embodiment of the invention; and

FIG. 11 is a perspective view showing the staple of FIG. 10 launched from the muzzle of a different type of staple gun.

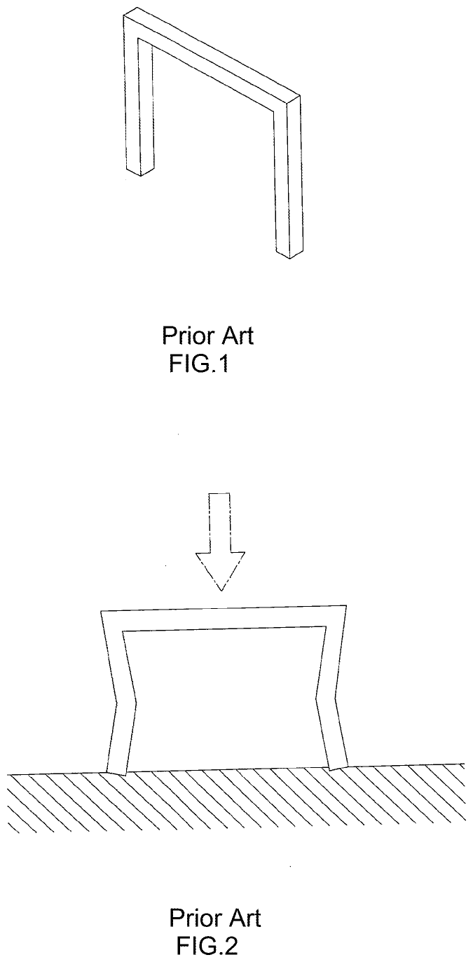

### DETAILED DESCRIPTION OF THE INVENTION

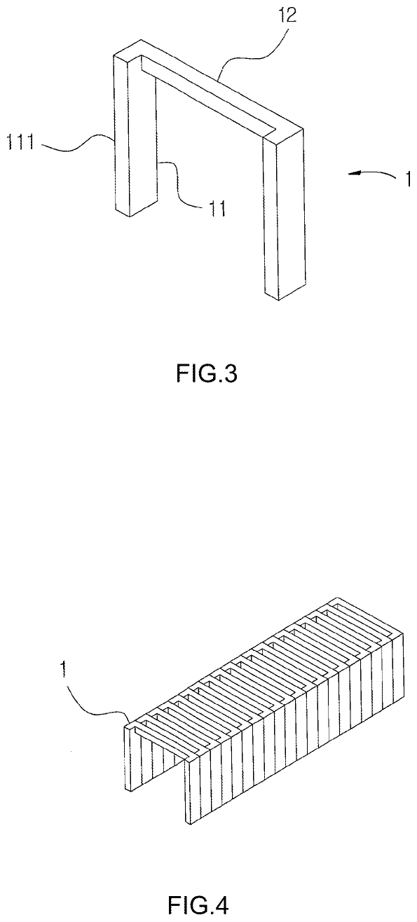

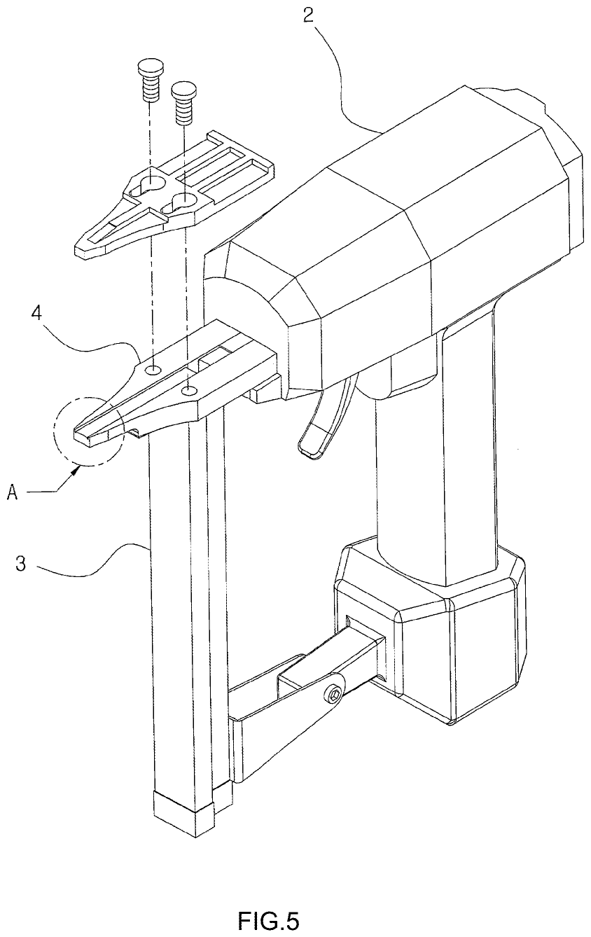

Referring to FIGS. 3 and 4, a U-shaped staple 1 in accordance with a first preferred embodiment of the invention comprises two legs 11 including a forward projection 111, and a connection member 12 having two ends formed with tops of the legs 11 respectively.

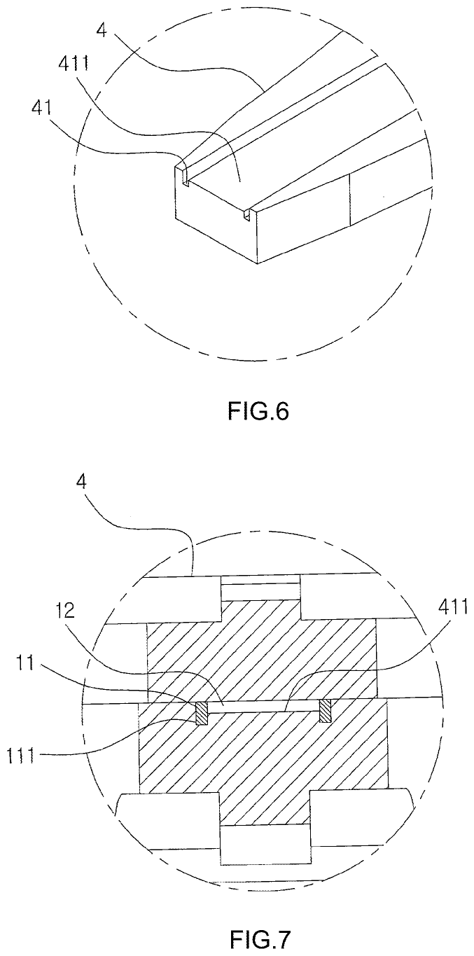

Referring to FIGS. 5 to 7, a staple gun in accordance with the invention comprises a gun body 2, a muzzle 4 formed with the gun body 2 and including a flat surface 411 and two grooved rails 41 at two sides of the sliding surface 411 respectively, and a cartridge 3 filled with long strips of staples and releasably secured to the muzzle 4. The forward projections 111 of the staple 1 are disposed in the grooved rails 41 respectively and the connection member 12 is rested upon the sliding surface 411.

In use, the staple 1 is launched from the muzzle 4. It is envisaged by the invention that the legs 11 of the staple 1 can be stably driven into a target to fasten the target because the forward projections 111 of the legs 11 are guided by the grooved rails 41 in the launching operation.

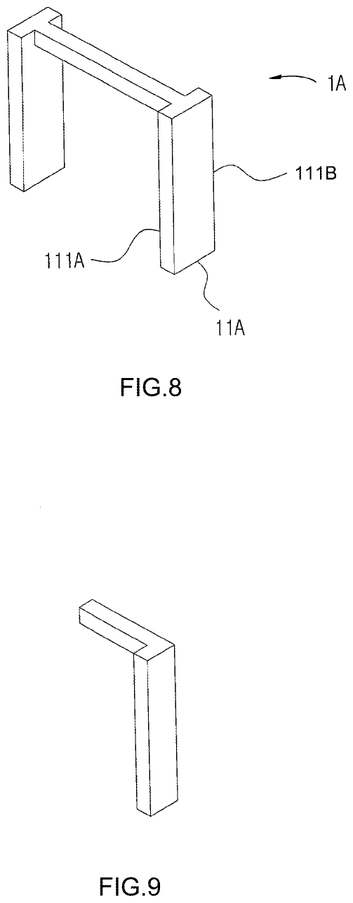

Referring to FIG. 8, a staple 1A in accordance with a second preferred embodiment of the invention is shown. The characteristics of the second preferred embodiment are substantially the same as that of the first preferred embodiment except the following: each leg 11A has a forward projection 111A and a rearward projection 111B.

Referring to FIG. 9, a staple in accordance with a third preferred embodiment of the invention is shown. The characteristics of the third preferred embodiment are substantially the same as that of the first preferred embodiment except the following: the staple is shaped as an L.

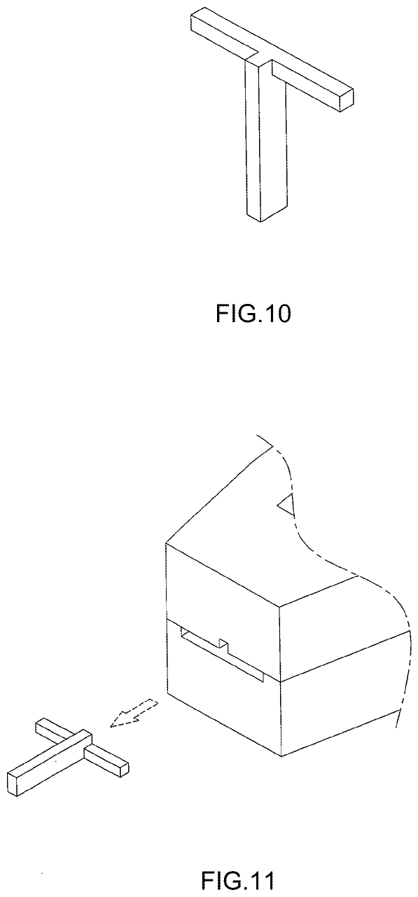

Referring to FIG. 10, a staple in accordance with a fourth preferred embodiment of the invention is shown. The characteristics of the fourth preferred embodiment are substantially the same as that of the first preferred embodiment except the following: the staple is shaped as a T.

Referring to FIG. 11, it shows the T-shaped staple of FIG. 10 being launched from a muzzle of a different type of staple gun. The muzzle has an inverted T-shaped longitudinal section.

While the invention has been described in terms of preferred embodiments, those skilled in the art will recognize that the invention can be practiced with modifications within the spirit and scope of the appended claims.

What is claimed is:

1. A staple comprising:
two legs each including a forward projection; and
a connection member having two ends formed with tops of the legs respectively.

2. The staple of claim 1, wherein each leg further comprises a rearward projection.
